(19) United States
(12) Patent Application Publication
(10) Pub. No.: US 2024/0044424 A1
(43) Pub. Date: Feb. 8, 2024

(54) SYSTEM FOR DETECTING A FAULT STATE OF A FLOATING TUBE

(71) Applicant: Dunlop Oil & Marine Ltd., Pyewipe (GB)

(72) Inventors: Simon Bishop, Beverley (GB); Paul Staton, Grimsby (GB)

(73) Assignee: Dunlop Oil & Marine Ltd., Pyewipe, OT (GB)

(21) Appl. No.: 18/253,778

(22) PCT Filed: Nov. 20, 2020
(86) PCT No.: PCT/EP2020/082887

§ 371 Date: May 20, 2023

(51) Int. Cl. F16L 11/133; B63B 79/10

(52) U.S. Cl. CPC F16L 11/133; B63B 79/10

(57) ABSTRACT

The invention relates to a system (2) for detecting a fault state of a floating tube (4), wherein the system (2) has a buoyant floating tube (4), a detection system (6), and an evaluation unit (8), wherein the detection system (6) is designed to detect the geometric arrangement of the floating tube (4) and/or to detect the floating state (10) of the floating tube (4) in order to generate a detection signal which represents the detected geometric arrangement of the floating tube (4) and/or the detected floating state (10) of the floating tube (4), wherein the detection system (6) and the evaluation unit (8) are coupled via a first signal connection (14) in order to transmit the detection signal from the detection system (6) to the evaluation unit (8). There are multiple possible fault states here which can be detected by the evaluation unit (8). These fault states include a crossed arrangement of tube portions (12) of the floating tube (4), tube portions (12) of the floating tube (4) which can be in a decoupled state from the rest of the floating tube (4), tube portions (12) of the floating tube (4) which are fully submerged in the water, and/or the detection of an at least partly coiled arrangement of the floating tube (4).

The invention relates to a system for detecting a fault state of a floating tube. Floating tubes are known from the prior art. A floating tube is often used in order to couple one end thereof to a buoyant buoy, so that the second end can serve for coupling and decoupling to and from a tanker. The floating tube can float together with the buoy in the water of a sea. The buoy can also be coupled to an underwater tube. A fluid connection between the underwater tube and the floating tube is established from the buoy. Fluid can thus be directed from the underwater tube through the buoy to the second end of the floating tube. This can be used, for example, when a fluid, in particular crude oil, is to be guided from the underwater tube to the tanker. In principle, a reverse flow direction for the fluid, in particular the crude oil, can also be provided. For example, crude oil can thus be pumped from the tanker through the floating tube to the buoy and then into the underwater tube. If the collection or the pumping of the fluid, in particular of the crude oil, is complete, the second end of the floating tube can be decoupled from the tanker. The floating tube then floats freely, at least with the second end, in the water of the sea. Until another tanker approaches the second end of the floating tube in order to couple the second end of the floating tube, a relatively long time may pass, in particular several hours or even days. The movement of the floating tube is influenced by the current of the water of the sea and/or by the wind above the water of the sea. In particular when the sea is rough, the floating tube may be damaged and/or even destroyed. If several floating tubes are attached to the same buoy, mutual mechanical damage to the floating tubes may also occur.

In practice, in order to prevent a tanker from approaching a floating tube and only upon arrival discovering that there is damage to the floating tube and therefore the floating tube cannot be used to convey fluid, a reconnaissance vessel is often sent to the floating tube prior to the arrival of the tanker so that the persons on the reconnaissance vessel can conduct an examination of the floating tube and report the results of this examination to the tanker so that the tanker can ensure that it is safe to convey fluid by means of the floating tube. Otherwise, other measures can be taken. For example, the tanker can be used for a different purpose. In addition, repair measures can be initiated in order to be able to put the floating tube back into operation as quickly as possible.

The object of the invention is to make it possible to detect a fault state of a floating tube as quickly and easily as possible and remotely.

The object of the invention is achieved by a system having the features of claim 1. A system for detecting a fault state of a floating tube is thus provided. The system has a buoyant floating tube, a detection system and an evaluation unit. The detection system is designed to detect the geometric arrangement of the floating tube and/or to detect a floating state of the floating tube. In addition, the detection system is configured to generate a detection signal, which represents the detected geometric arrangement of the floating tube and/or the detected floating state of the floating tube. The detection system and the evaluation unit are coupled via a first signal connection in order to transmit the detection signal from the detection system to the evaluation unit. The evaluation unit is configured (a) on the basis of the geometric arrangement, to detect a first fault state of the floating tube if tube portions of the floating tube are arranged crossing one another, (b) on the basis of the geometric arrangement, to detect a second fault state of the floating tube if a tube portion of the floating tube is in a decoupled state from the rest of the floating tube, (c) on the basis of the floating state, to detect a third fault state of the floating tube if a tube portion of the floating tube is fully submerged in the water, and/or (d) on the basis of the geometric arrangement, to detect a fourth fault state of the floating tube if the floating tube is arranged in an at least partly coiled manner.

The system allows an automatic and thus also particularly quick detection of a fault state of the floating tube. The system for this purpose has the floating tube and the detection system, wherein the detection system detects the geometric arrangement of the floating tube or a floating state of the floating tube. The floating state may represent a flotation depth of the floating tube and/or be determined thereby. The floating tube can have multiple buoyant tube segments, which are arranged in succession and are coupled to one another to form a tube strand. This tube strand forms an advantageous embodiment of the floating tube. If the floating tube has multiple tube segments, the floating state can thus represent and/or be determined by the flotation depth of each of the tube segments. The floating state of a tube segment can be positive if this tube segment is arranged floatingly at least partly above the water line. The floating state of a tube segment can be negative if the tube segment in question is fully below the water line or is fully submerged in the water. In an advantageous embodiment the floating state of the floating tube can be formed by the floating states for the tube segments. In this case the floating state of the floating tube can represent the flotation depth for each tube segment. In order to detect the floating state of the floating tube, there are various possibilities for the design of the detection system. For example, the detection system can have an imaging camera in order to capture an image of the floating tube in the water. On the basis of pattern recognition of the captured image, it is then possible to detect which of the tube segments of the floating tube are arranged floatingly at least partially above the water line and whether at least one of the tube segments is not shown in the captured image and therefore is detected as a submerged tube segment. The patter recognition in this case can detect the number of tube segments and preferably the length of each of these. Corresponding data can be stored on a memory of the detection system. In addition, the detection system can have a processor unit in order to carry out the aforementioned pattern recognition. The detection system can also comprise the stated camera for capturing an image of the floating tube. The floating state of the floating tube can also be captured, however, by another advantageous design of the detection system. For example, the detection system can have, for example, a plurality of node units, wherein each node unit is formed by means of an associated radio unit for establishing a radio connection to two further radio units. A radio network can be formed as a result. Each or a plurality of the tube segments can have a corresponding node unit and/or the node unit can be attached to the tube segment in question. The radio connection from one node unit to a further of the node units, however, is only established as long as the node unit and/or an associated antenna of the node unit is above the water line. Only then can a radio connection formed over the air be created. On the basis of the aforementioned radio network, it is therefore possible to identify the radio units that are not part of the radio network. The detection system can be designed for a corresponding identification. The detection system can thus detect that the tube segments with a node unit attached thereto are floating when the corresponding radio unit participates in the radio network by establishing a radio connection. However, tube segments for which the node unit attached thereto does not establish and/or form a radio connection to the radio network can be detected by the detection system as a submerged tube segment. The detection system may be aware of the number of node units provided for the floating tube and to which of the tube segments the corresponding node unit is assigned. The detection system can therefore be designed to detect the submerged tube segments on the basis of the radio connections of the radio network and to identify the associated tube segments in each case as submerged. The node units participating in the radio network and the associated tube segments are therefore identified by the detection system as floating tube segments. The detection system can therefore detect a floating state of the floating tube, wherein the floating state represents each of the tube segments as either floating or fully submerged.

A geometric arrangement of the floating tube can be understood to mean, for example, a spatial structure and/or a spatial arrangement of the floating tube. The geometric arrangement can be determined and/or represented, for example, by spatial coordinates, for example in a plane, of the floating tube. As an alternative or in addition, the geometric arrangement can be determined and/or represented, for example, by spatial coordinates, preferably in a plane, of the tube segments. The geometric arrangement can, alternatively or additionally, also be based for example on a spatial orientation of the floating tube and/or of the preferably associated tube segments. The geometric arrangement of the floating tube can therefore provide information about how and/or the geometric form in which the floating tube is arranged.

The detection system is preferably attached at least partially to the floating tube. In particular, the detection system can be embedded partially in the floating tube. For example, the node units can be embedded at least partially in an outer wall of each of the floating tubes. The fixed coupling of the detection system to the floating tube is not absolutely necessary, however. If the detection system is embodied with the optical camera, for example, the detection system can thus be attached for example to a buoy which is connected to a first end of the floating tube. The camera can then be oriented in order to detect the floating tube optically.

The evaluation unit is coupled via the signal connection to the detection system. In an advantageous embodiment the evaluation unit is also directly mechanically connected to the detection system and/or the evaluation unit and the detection system can be formed in an at least partially integrated manner. The evaluation unit for example can thus likewise be attached to the floating tube and/or the buoy. For a particularly preferred embodiment, however, the evaluation unit is spatially separated from the detection system. For example, it is preferably provided that the evaluation unit is physically and spatially separated from the detection system. For example, the evaluation unit can be arranged on land or on a vessel. The first signal connection between the detection system and the evaluation unit can be formed partially or fully as a wireless signal connection, in particular a signal connection via radio. This offers the advantage that the detection of the fault state of the floating tube can also be performed particularly quickly by means of the evaluation unit with a particularly high processing power. The evaluation unit, for example, can be embodied by a computer cloud network. This is just one advantageous design option, however. The first signal connection can be made, for example, via a satellite and/or other communication node. For example, the first signal connection can be made via a satellite and from this via further satellites to a land station, from which the first signal connection leads via cable to the evaluation unit. The detection signal is transmitted from the detection system to the evaluation unit via the first signal connection. The evaluation unit therefore makes available the information about the geometric arrangement of the floating tube and/or the floating state of the floating tube. The evaluation unit is configured to detect the first fault state, the second fault state, the third fault state and/or the fourth fault state. For example, the evaluation unit can be configured to detect just one of the aforementioned fault states. However, it is also possible that the evaluation unit is designed to detect a plurality of the aforementioned fault states. Lastly, it is possible that the evaluation unit is configured to detect each of the aforementioned fault states. The configuration of the evaluation unit will be explained hereinafter in conjunction with each of the aforementioned fault states individually. However, it should not necessarily follow from this that only one of the configurations explained may be provided for the evaluation unit. This is possible, though, in principle. It can also be provided, however, that a plurality of the previously explained configurations and/or all of the configurations explained hereinafter can be provided for the evaluation unit.

It is preferably provided that the evaluation unit is configured, on the basis of the geometric arrangement, to detect a first fault state of the floating tube if tube portions of the floating tube are arranged crossing one another. The geometric arrangement relates here to the geometric arrangement of the floating tube detected by the detection system. The corresponding information is provided to the evaluation unit, since the evaluation unit is coupled via the first signal connection to the detection system and, as a result of this, the detection signal can be transmitted to the evaluation unit.

The geometric arrangement of the floating tube can represent the geometric form and/or the spatial arrangement of the floating tube. If the geometric form of the floating tube is formed, for example, in the manner of a loop, there are at least two tube portions and/or two tube segments, which are arranged crossing one another. Each tube portion can be formed by a single tube segment. It is, however, also possible that one or each of the tube portions is formed by a plurality of tube segments of the floating tube. The crossing arrangement of the tube portions of the floating tube can then occur, for example, when the floating tube forms the loop and thus a tube portion of the floating tube rests on another tube portion of the floating tube. The two tube portions, to this end, do not necessarily have to be arranged at an angle of 90 degrees to one another. Rather, it may also be possible that the tube portions are arranged at an acute angle and/or at a flat angle relative to one another.

Tube portions arranged crossing one another can be detected by the evaluation unit on the basis of the geometric arrangement of the floating tube. The evaluation unit can be configured correspondingly for this purpose. Crossing tube portions of the floating tube should be avoided where possible, since the crossing tube portions are exposed to a particularly high mechanical load during use of the floating tube. The geometric arrangement of the floating tube may therefore be incorrect since it comprises tube portions crossing one another. A first fault state is therefore detected for this floating tube by the evaluation unit.

Alternatively or additionally it can be provided that the evaluation unit is configured, on the basis of the geometric arrangement, to detect a second fault state of the floating tube if a tube portion of the floating tube is arranged in a decoupled state from the rest of the floating tube. The geometric arrangement is the geometric arrangement of the floating tube that is detected by the detection system. If a tube portion decouples from the rest of the floating tube, the geometric arrangement of the floating tube will thus likewise represent the greater distance, created by the separation, between the separated tube portion and the rest of the tube.

Information as to which maximum portions may exist maximally between the tube segments and/or between two proportions of the floating tube can be stored by the evaluation unit. If the distance between two of the stated tube segments and/or tube proportions is greater than the corresponding maximum distance, this can be detected by the evaluation unit on the basis of the geometric arrangement and preferably on the basis of the stored maximum distance between the tube segments and/or tube portions. The evaluation unit is preferably configured accordingly for this purpose. If the maximum distances are of the same size, a single maximum distance can thus be used instead of the aforementioned maximum distances. If, for example, two contiguous tube segments at the second end of the floating tube decouple from the remaining tube segments of the floating tube, so that an increased distance is created between the two separated tube segments and the remaining tube segments, this is likewise represented by the geometric arrangement of the entire floating tube. The distance between the tube segments where the separation occurs in this case exceeds the maximum distance between the tube segments. This maximum distance between the tube segments can be stored by the evaluation unit. The evaluation unit can additionally be configured to determine the second fault state of the floating tube on the basis of the geometric arrangement of the entire floating tube and the maximum distance between the tube segments. Similarly to the maximum distance between two tube segments, a tube portion decoupled from the rest of the tube portion of the floating tube can also be identified on the basis of the angle between the separated part of the tube portion and the remaining tube portion. This is because usually the tube portions can only be arranged at a limited angle relative to one another. This angle can be stored as a limit value angle by the evaluation unit. If the angle, represented by the geometric arrangement, between the separated tube portion and the remaining tube portion is greater than the predetermined limit value angle, this can be detected by the evaluation unit and thereupon the second fault state of the floating tube can be detected. A combination of the aforementioned possibilities is likewise possible. The evaluation unit can be configured correspondingly for this purpose.

Alternatively or additionally it can be provided that the evaluation unit is configured, on the basis of the floating state, to detect a third fault state of the floating tube if a tube portion of the floating tube is fully submerged in water. Regarding the detection of the floating state of the floating tube, it has already been pointed out that the floating state may refer to the entire floating tube as a unit and/or that the floating state of the floating tube may represent the associated floating state for each tube segment of the floating tube. The floating state in this case can assume a corresponding value that indicates whether the tube segment in question is floating or fully submerged. A floating state for the entire floating tube can be generated from the individual floating states of the tube segments. The detection system can be designed and/or configured correspondingly for this purpose. On the basis of the floating state, the evaluation unit can therefore identify whether a tube portion of the floating tube is fully submerged in water. The tube portion can be formed here by an individual tube segment of the floating tube. It is, however, also possible that the tube portion is formed by a plurality of tube segments of the floating tube. Full submersion of the tube portion in the water may occur, for example, at the second end of the floating tube, wherein the opposite first end of the floating tube is attached to a buoy. The second end of the floating tube and the tube portion of the floating tube adjacent thereto may then, for example, be submerged in the water if the second end of the floating tube has a defect and/or fault. If, for example, a valve is arranged at the second end of the floating tube in order to close the second end of the floating tube, a defectively opened valve may thus cause water to enter the interior of the floating tube and thereby cause and/or at least promote submersion of the second end of the floating tube. However, there may also be another reason causing a submersion of a tube portion of the floating tube. For example, if the stated tube portion of the floating tube were to be run over by a large vessel or if there were to be a collision between the tube portion and a vessel, there may be damage to the tube portion that causes the tube portion to be submerged in the water. The tube portion submerged in the water does not necessarily have to be at an end of the floating tube. For example, it is also possible that a tube portion arranged between the ends of the floating tube is fully submerged in the water. Based on the floating state of the floating tube and therefore preferably based on the floating state of each of the tube segments of the floating tube, the evaluation unit can identify the tube segments that are fully submerged in the water. On this basis, the evaluation unit can therefore identify the tube portion that is fully submerged in the water. If this has been identified by the evaluation unit, the third fault state of the floating tube is detected by the evaluation unit. It can preferably be provided that the third fault state is detected positively by the evaluation unit only if the tube portion of the floating tube is fully submerged in water for at least a predetermined period of time. This can prevent submersion of a tube portion for only a short time from already resulting in detection of the third fault state. Particularly in the case of a strong swell, it may come to be in practice that a portion of the floating tube is temporarily covered by water and/or submerged in water. Usually, however, this does not last very long, and the floating tube floats up again. In order to prevent this temporary submersion of the floating tube from being detected as the third fault state, it can therefore be provided that the immersion must be present at least for the aforementioned, predetermined period of time in order for the third fault state to be detected positively by the evaluation unit.

Alternatively or additionally it can be provided that the evaluation unit is configured, on the basis of the geometric arrangement, to detect a fourth fault state of the floating tube if the floating tube is arranged in an at least partially coiled manner. The geometric arrangement relates here to the geometric arrangement of the floating tube detected by the detection system. This corresponding information is available to the evaluation unit. The floating tube is often attached by a first end to a buoy. The current and/or the wind can move the second end of the floating tube around the buoy, so that one or more windings of the floating tube around the buoy are created. The floating tube is then preferably arranged in a coiled manner if at least one complete winding of the floating tube is formed around an object. The geometric arrangement of the floating tube can represent the geometric form of the floating tube. Therefore, the geometric arrangement can also be determined on the basis of the coiling of the floating tube. The evaluation unit can be configured to detect a coiling of the floating tube on the basis of the geometric arrangement of the floating tube. If the evaluation unit detects the coiling of the floating tube, it thus also detects the fourth fault state of the floating tube.

In order to detect at least one or each of the fault states, the evaluation unit can be configured to perform pattern recognition on the basis of the geometric arrangement or the floating state of the floating tube. If corresponding patterns are detected by the evaluation unit, each detected pattern can thus be assigned to one of the aforementioned fault states. The evaluation unit can thus preferably be designed and/or configured to detect one or each of the fault states by means of pattern recognition.

An advantageous embodiment of the system is distinguished in that the floating tube has a plurality of tube segments that are coupled to one another in series. The coupling is preferably a mechanical coupling. The tube segments can thus be arranged one behind the other and connected to one another at their end faces in a frictionally engaged and/or interlocking manner, so that a strand of tube segments is created. This can also be referred to as a tube strand and/or can form the floating tube.

An advantageous embodiment of the system is distinguished in that the detection system is at least partially attached to the floating tube. The detection system can be of a multi-part design. One part or a plurality of parts of the detection system can be attached to the floating tube. The parts of the detection system attached to the floating tube can thus be arranged in a manner evenly distributed over the length of the floating tube. In particular, it is possible that at least part of the detection system is associated with each tube segment of the floating tube and/or is attached to the corresponding tube segment. This allows particularly precise detection of the geometric arrangement of the floating tube.

An advantageous embodiment of the system is distinguished in that the system has a buoyant buoy, wherein a first end of the floating tube is connected to the buoy. This is preferably a mechanical coupling. The first end of the floating tube can thus be connected to the buoy in a frictionally engaged and/or interlocking manner. A fluid connection can thus also be established between the floating tube and the buoy. The buoy can additionally have a further connection. This connection can be used to couple an underwater tube to the buoy. This may likewise be a frictionally engaged and/or interlocking connection. In addition, the underwater tube can establish a fluid connection to the buoy by means of the stated connection. Thus, a fluid connection can be established overall between the underwater tube and the floating tube by means of the buoy. The buoy is likewise buoyant. The floating tube and the buoy can thus form a buoyant unit, in particular a floating unit. The floating unit can be part of the system.

An advantageous embodiment of the system is distinguished in that the detection system is at least partially attached to the buoy. One part or a plurality of parts of the detection system can thus be attached to the buoy. The other parts of the detection system can be attached, for example, to the floating tube. The detection system can thus be distributed over the buoy and the floating tube. However, it is also possible for the entire detection system to be attached to the buoy. This may be the case, for example, if the detection system has a camera by means of which the floating tube is optically captured.

A further advantageous embodiment of the system is distinguished in that the detection system has a plurality of node units, wherein each node unit is designed, by means of an associated radio unit, to establish a radio connection to each of at least two of the further radio units of the node unit in question, so that a radio network, in particular a mesh radio network, is created, wherein the node units are arranged in a manner distributed over the length of the floating tube or are arranged in a manner distributed between the buoy and a second end of the floating tube. Thus, a radio network is formed by the radio connections between the plurality of node units and allows communication with each of the node units. If the radio connection of one of the node units to the radio network is interrupted, this can thus be detected by the detection system. The detection system can be designed and/or configured for this purpose. Based on the interruption of the radio connection to a node unit, the detection system can identify the tube segment or the tube portion of the floating tube to which the particular node unit is attached to which the radio connection is interrupted. Thus, the detection system can be designed and/or configured to identify a tube portion submerged in water and/or a tube segment submerged in water on the basis of the interrupted radio connection to one of the node units. On this basis, the detection system can be designed and/or configured to detect the floating state of the floating tube, in particular the floating state for each of the tube segments and/or tube portions of the floating tube. Alternatively or additionally, the detection system can be designed and/or configured to detect the geometric arrangement of the floating tube on the basis of the radio network.

An advantageous embodiment of the system is distinguished in that each node unit is designed to determine a relative distance to each further node unit, connected via a radio connection, on the basis of the corresponding radio connection, wherein at least one of the node units forms a main unit which is designed to collect the relative distances, determined by the further node units, via the radio connections and/or the radio network, and wherein the main unit is designed to determine the geometric arrangement of the floating tube on the basis of the collected relative distances.

The relative distances preferably relate to the distances between the node units and/or to the distances from the main unit to each further node unit. The distances can comprise in particular the distances between adjacent node units along the floating tube. The relative distances determined by means of the radio connections can, however, preferably relate to the relative distances between the main unit and each of the further node units. By means of the relative distances determined by the radio connections, it is possible to geometrically map the geometric arrangement of the floating tube.

The node units have the radio units to determine the relative distances. The radio connections can be established by means of the radio units, with the result that a radio network, in particular the mesh network, is produced. Radio signals can be exchanged via the radio connections. In this case, the radio signals have a propagation time between the transmission and the subsequent reception. The radio signals can therefore be used to ascertain the distance between the corresponding radio units. For this purpose, the node units and/or the main unit are designed accordingly. The radio connections serve, in particular, to determine the relative distances between the node units and preferably to determine the relative distances between the main unit and each of the further node units. In addition, it can be provided that each radio unit is configured in such a way that the geometric arrangement and/or the relative distances are determined by triangulation on the basis of the propagation times over the radio connections. In particular the main unit, and particularly preferably exclusively the main unit, can be configured and/or designed for this purpose. In this case, the propagation times can be measured by each of the node units and the corresponding information transmitted to the main unit via the radio network. However, it is also possible that each of the node units is configured to determine the relative distances by triangulation on the basis of the propagation times of the radio signals of the radio connections that exist with the corresponding radio unit. Each of the node units can be part of the detection system. Thus, for example, a plurality of the node units or all node units can be fixedly connected to the floating tube. However, it is also possible for at least one of the node units to be fixedly connected to the buoy. This node unit can form the main unit. Alternatively or additionally, provision can be made for in each case one of the node units to be connected to precisely in each case one tube segment of the floating tube. However, it is also possible for the node units to be arranged in a manner distributed in such a way that each second or each third tube segment is fixedly connected to one of the node units. Other distributions of the node units can likewise be provided.

A further advantageous embodiment of the system is distinguished in that the main unit is configured to determine the length of the tube portions of the floating tube and/or the distances between the tube portions of the floating tube on the basis of the collected relative distances, so that the geometric arrangement represents at least also the length of the tube portions and/or the distances between the two proportions. The evaluation unit can be configured to detect a missing mechanical connection between two tube portions arranged in series one behind the other on the basis of the length of the tube portions and/or the distances between the tube portions. Each tube portion can be formed by one or more tube segments of the floating tube. The evaluation unit can be designed such that a reference length of each tube portion and/or a reference distance between two adjacent tube portions are stored by the evaluation unit. The evaluation unit can be configured to detect a length excess if the determined length of a tube portion is longer than the associated reference length. In addition, the evaluation unit can be configured to determine and/or to detect a missing mechanical connection between two tube portions on the basis of the length excess. Alternatively and/or additionally, the evaluation unit can be designed and/or configured to detect a distance excess if the determined distance between two adjacent tube portions is longer than the associated reference distance. In addition, the evaluation unit can be configured to determine and/or detect a missing mechanical connection between two adjacent tube portions on the basis of the detected distance excess. If a missing mechanical connection between two adjacent tube portions is detected by the evaluation unit, the second fault state can thus be identified by the evaluation unit.

A further advantageous embodiment of the system is distinguished in that the main unit or a main unit formed by one of the node units is configured to establish a direct or indirect radio connection to each further node unit via the radio network, wherein the main unit is additionally configured to identify each node unit connected to the main unit by the corresponding radio connection as a floating node unit, and wherein the main unit is configured to identify each node unit not connected to the main unit by a radio connection as a submerged node unit, and wherein the main unit is configured to determine the floating state of the floating tube on the basis of the identification of the floating node units and/or the submerged node units in such a way that the floating state for each tube portion of the floating tube indicates whether the particular tube portion is either floating or submerged. For example, on the basis of the identification of the floating and/or submerged node units, the main unit can thus identify as submerged the tube portion to which a submerged node unit is attached. Alternatively and/or additionally, the main unit can be configured to identify as floating the tube portion of the floating tube to which a floating node unit is connected. Thus, by means of the identification of the floating and submerged node units, it is possible to divide the tube portions of the floating tube into submerged and floating tube portions. In principle, it is also possible here that all tube portions of the floating tube are detected as floating or as submerged. However, it may also be that only one tube portion of the floating tube is indicated as floating or submerged. Each tube portion can be indicated as floating or submerged accordingly. Thus, a floating state for the entire floating tube can be determined by the main unit. The main unit can be configured and/or designed for this purpose. The floating state of the floating tube can thus represent the indication for each tube portion in such a way that is indicated for each tube portion whether the tube portion in question is either floating or submerged. On the basis of this floating state, the evaluation unit can detect the third fault state of the floating tube if at least one tube portion of the floating tube is indicated as submerged.

A further advantageous embodiment of the system is distinguished in that the detection system is designed to transmit the detection signal to the evaluation unit via the first signal connection. The detection system can thus transmit the detection signal to the evaluation unit without prior request. A unidirectional transmission of the detection signal from the detection system to the evaluation unit can thus take place. This is advantageous in particular if the detection signal is transmitted partially via the first signal connection via a satellite.

An advantageous embodiment of the system is distinguished in that the signal connection is at least partially in the form of a wireless signal connection. The first signal connection can thus be established at least partially via radio. The first signal connection, however, can also be wired. For example, the first signal connection can be established via a wired signal connection to the first buoy and thus to at least part of the detection system that is arranged and/or formed on the buoy. However, it is also possible that the first signal connection is established at least substantially exclusively via radio. This may be the case for example in particular if the evaluation unit is installed on a vessel. In this case, the detection system can establish the first signal connection via radio to the evaluation unit in order to transmit the detection signal from the detection system to the evaluation unit.

An advantageous embodiment of the system is distinguished in that the evaluation unit is arranged at a distance from the floating tube and/or the detection system. The evaluation unit, for this purpose, can be formed physically separately from the floating tube and/or the detection system. The evaluation unit is preferably arranged on land, whereas the floating tube and/or the detection system float on the water. The evaluation unit can thus have a particularly high processor power, which may have a high electrical power requirement.

An advantageous embodiment of the system is distinguished in that the evaluation unit is a stationary evaluation unit. The evaluation unit can thus be arranged in a stationary and fixed manner on land. The evaluation unit can thus also be serviced and/or updated particularly easily.

Further features, advantages and possible applications of the present invention can be gleaned from the following description of the exemplary embodiments and the figures. Here, all of the features described and/or illustrated in the figures form the subject matter of the invention individually and in any desired combination, even independently of the composition thereof in the individual claims, or the back-references therein. In the figures, furthermore identical reference symbols are used for identical or similar objects.

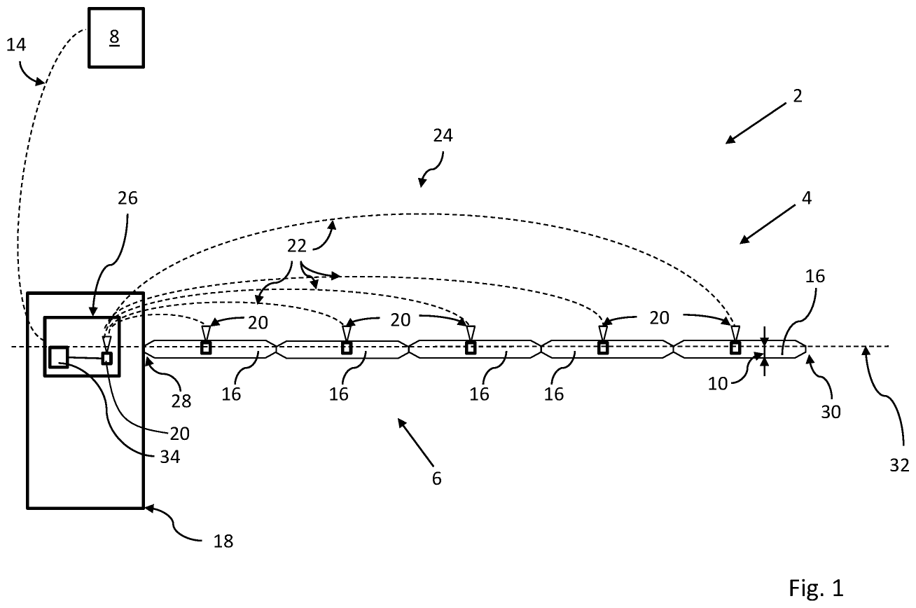

FIG. 1 shows a schematic cross-sectional view of an advantageous embodiment of the system.

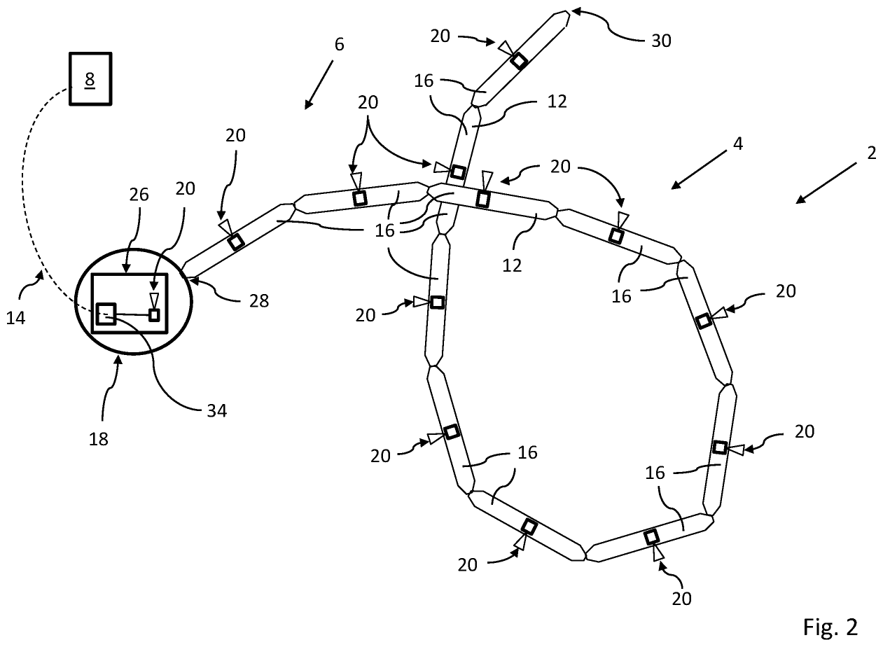

FIG. 2 shows a further advantageous embodiment of the system, wherein the associated floating tube is in a first fault state.

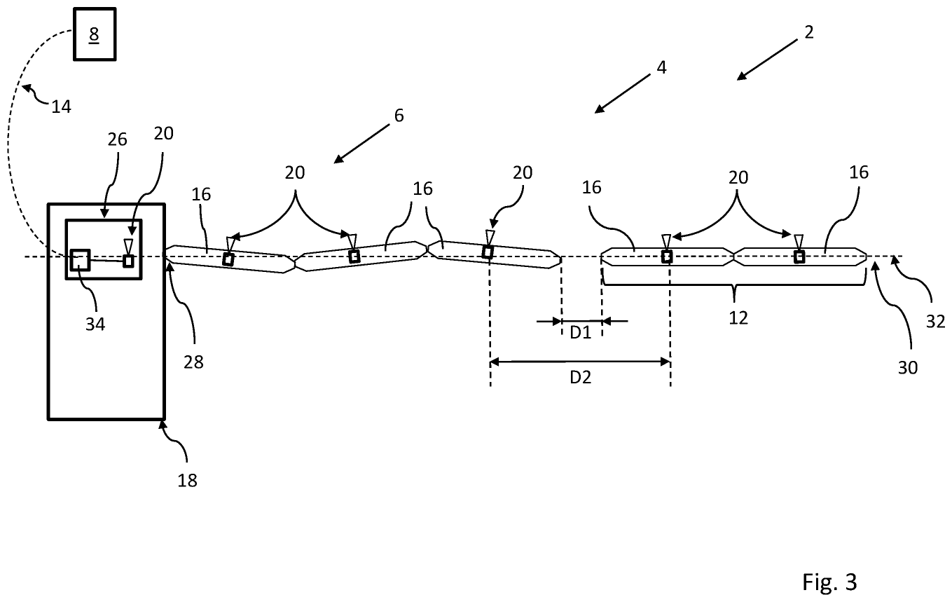

FIG. 3 shows the system from FIG. 1, wherein the associated floating tube is in a second fault state.

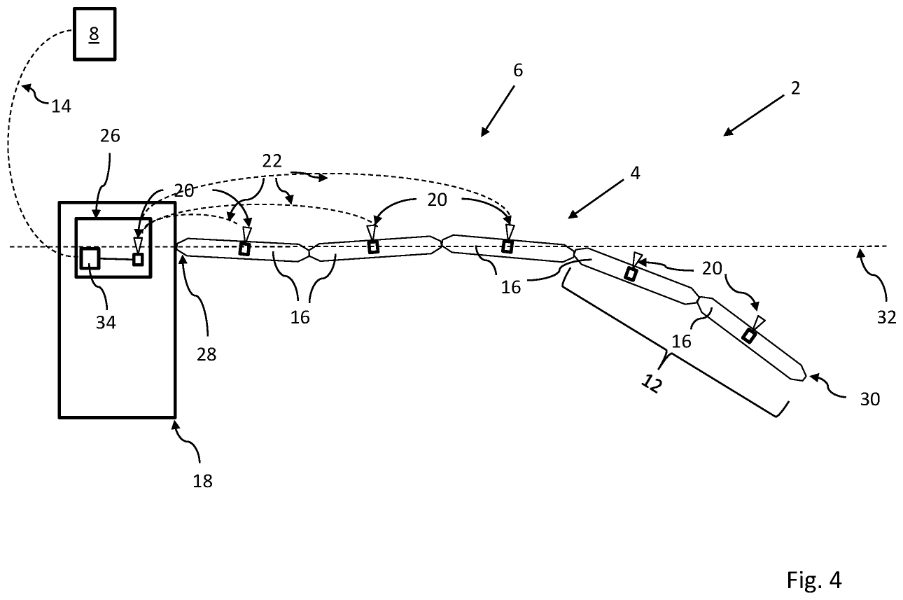

FIG. 4 shows the system from FIG. 1, wherein the floating tube is in a third fault state.

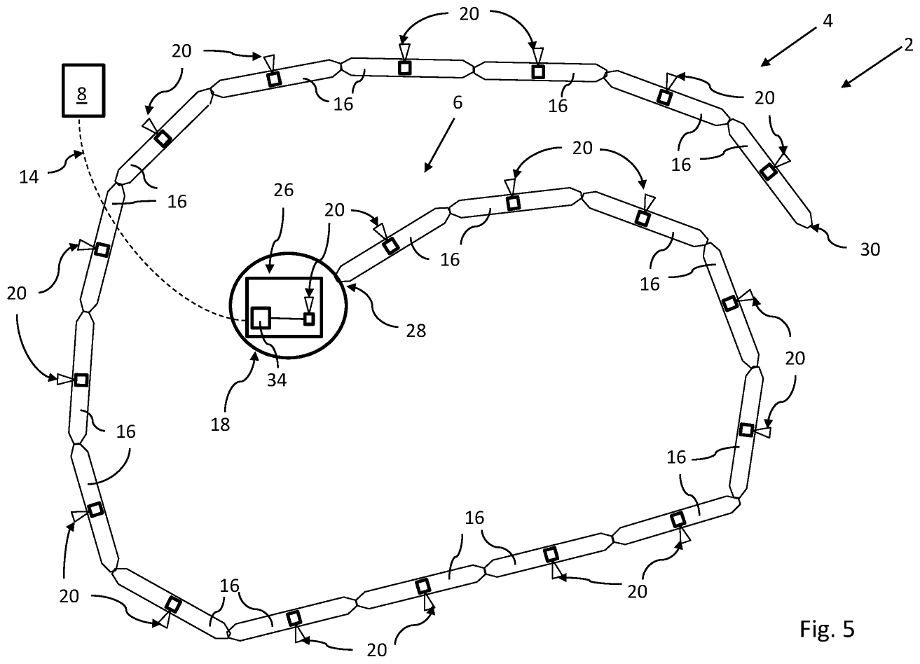

FIG. 5 shows a schematic plan view of a further advantageous embodiment of the system.

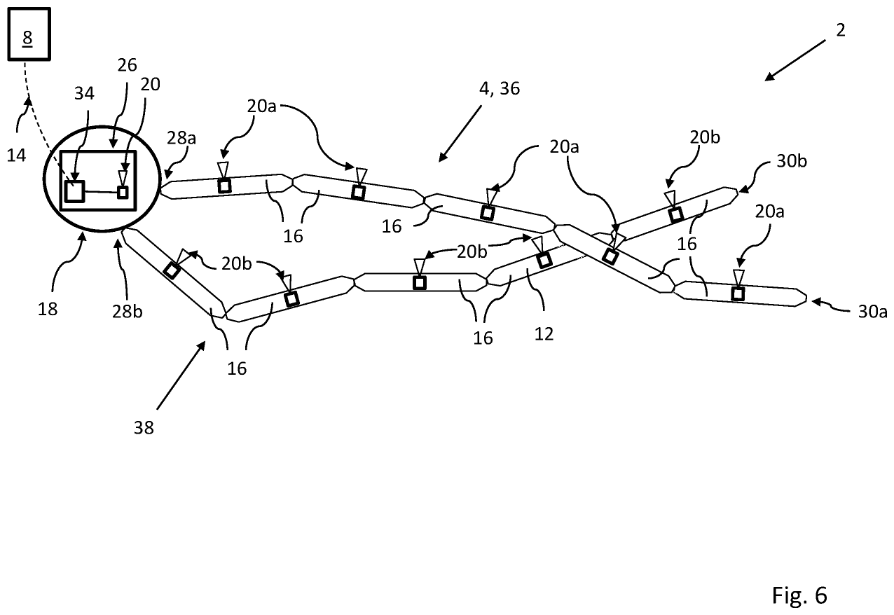

FIG. 6 shows a schematic plan view of a further advantageous embodiment of the system 2 from FIG. 1.

FIG. 1 shows a schematic cross-sectional view of an advantageous embodiment of the system 2. The system 2 allows a detection of a fault state of a floating tube 4. The system 2 has the buoyant floating tube 4, a detection system 6 and an evaluation unit 8. The detection system 6 is preferably of a multi-part design. The detection system 6 can be formed, for example, by a plurality of node units 20. One of the node units 20 can form a main unit 26, or the main unit 26 can comprise at least the corresponding node unit 20. The main unit 26 is likewise part of the detection system 6. The parts of the detection system 6 are arranged in a distributed manner. It can additionally be provided for the system 2 that the system 2 has a buoyant buoy 18. The main unit 26 can be associated with the buoy 18 or can be attached to the buoy 18. A first end 28 of the floating tube 4 is attached to the buoy 18. The floating tube 4 extends from the first end 28 to a second end 30. The floating tube 4 can be of a multi-part design. For example, the floating tube 4 can be formed by a plurality of tube segments 16 that are coupled to one another in series one behind the other. The adjacent the arranged tube segments 16 can be releasably attached to one another in such a way that the entire floating tube 4 forms a continuous flow channel. Each of the tube segments 16 is buoyant. Therefore, the entire floating tube 4 is also buoyant. The buoy 18 is likewise buoyant. The floating tube 4 and the buoy 18 can be constructed and/or designed for example in such a way that in each case approximately 20 to 35% of the associated body is arranged above a water line 32. The waterline 32 is indicated in FIG. 1 by a dashed line. The flotation depth 10 is likewise illustrated in FIG. 1. In the variant of the system 2 shown in FIG. 1, the parts of the detection system 6 are arranged in a manner distributed between the buoy 18 and the second end 30 of the floating tube 4. The main unit 26 of the detection system 6 is attached to the buoy 18. The further node units 20 of the detection system 6 are attached to the tube segments 16 of the floating tube 4. For example, it can preferably be provided that a node unit 20 is attached to and/or arranged on each of the tube segments 16. Each of the node units 20 and the main unit 26 can establish a radio connection 22 to the other node units 20 and/or the main unit 26. A radio network 24 can be formed as a result. By means of the radio network 24, the distance between the node units 20 or the distance between the main unit 26 and each of the node units 20 can be determined. This can be determined by the propagation time of the corresponding radio connection 22. It is therefore possible to determine the geometric form of the floating tube 4 relative to the buoy 18 by way of triangulation. The main unit 26 of the detection system 6 can be designed to detect the propagation times of the radio connections 22 and to determine the geometric form of the floating tube 4 relative to the buoy 18. The geometric form of the floating tube 4 relative to the buoy 18 can represent the geometric arrangement of the floating tube 4. The detection system 6 is therefore designed to detect the geometric arrangement of the floating tube 4.

In addition, it can be provided that the main unit 26 of the detection system 6 has stored the number of further node units 20 and corresponding identification data for the various node units 20. The main unit 26 can therefore detect, by the radio connections 22 and/or by the radio network 24, whether a direct or indirect radio connection 22 can be established to each of the further node units 20. If it is not possible to establish a direct or indirect radio connection 22 to one of the further node units 20 from the main unit 26, the main unit 26 can thus be configured to determine the relevant node unit 20 as a submerged node unit 20. This is because it has been found in practice that the radio connection 22 is interrupted as soon as the associated node unit 20 is fully submerged in water. If this is the case, it can additionally be assumed that the tube segment 16 on/to which the particular node unit 20 is attached and/or arranged is likewise fully submerged in water. The main unit 26 can therefore detect, via the radio connections 22 or the radio network 24, which of the tube segments 16 is submerged and which of the tube segments 16 is floating. A floating state of the floating tube 4 may indicate which of the tube segments 16 of the floating tube 4 are floating and/or which tube segments 16 of the floating tube 4 are fully submerged. Since the particular floating state of each of the tube segments 16 can be detected by the main unit 26, the main unit 26 is likewise designed to detect the floating state of the floating tube 4. This is because this floating state on the one hand can represent the floating state of the entire floating tube 4 or can represent the floating state for each of the tube segments 16 of the floating tube 4.

The main unit 26 and each of the node units 20 are preferably formed as an electric unit. They therefore require electrical energy for operation. Each of the node units 20 and the main unit 26 can have an associated battery in each case in order to ensure electrical energy for operation of the particular node unit 20 or the main unit 26. Alternatively or additionally, each of the node units 20 and/or the main unit 26 can have further energy sources. For example, each of the node units 20 and/or the main unit 26 can have a solar cell, which is designed to generate electrical energy from light, in particular sunlight. At least some of the electrical energy that is required to operate the particular node unit 20 of the main unit 26 can therefore likewise be provided by means of the solar cell.

The detection system 6 is configured, for this purpose, to generate a detection signal, which represents the detected geometric arrangement of the floating tube 4 and/or the detected floating state of the floating tube 4. For example, the main unit 26 can be configured to generate the detection signal. This is because the main unit 26 is preferably also designed to detect the geometric arrangement of the floating tube 4 and/or the floating state of the floating tube 4. In addition, the detection system 6 is designed to transmit the detection signal to the evaluation unit 8. The detection system 6 and the evaluation unit 8 can be designed to establish a first signal connection 14 between the detection system 6 and the evaluation unit 8. This first signal connection is established in practice. The detection system 6 and the evaluation unit 8 can additionally be designed to transmit the detection signal from the detection system 6 to the evaluation unit 8 via the first signal connection 14. The main unit 26 of the detection system 6 can have, for this purpose, a communication unit 34 for example, which is designed to transmit the detection signal via the first signal connection 14. The first signal connection 14 can be in the form of a radio connection.

It has proven to be advantageous if the evaluation unit 8 is physically separate and removed from the detection system 6 and/or the floating tube 4. The evaluation unit 8 can be arranged for example in stationary fashion on land. The floating tube 4 can be floating in the water of the sea. The detection system 6 can be arranged in a distributed manner on the floating tube 4 or distributed between the buoy 18 and the floating tube 4. The detection signal can be transmitted from the detection system 6 to the evaluation unit 8 via the first signal connection 14. The first signal connection 14 is used for this purpose. The evaluation unit 8 can be equipped with a sufficiently high processor power to allow the detection of at least one of the possible fault states of the floating tube 4. The electrical power supply of the processing unit is unproblematic in this case. The electrical power supply of the detection system 6 can be provided via batteries and/or via solar cells. The floating tube 4 and the detection system 6 can therefore be used particularly easily without having to be connected to a fixed electrical power supply. The evaluation unit 8 can additionally be coupled to further units, which are suitable and/or designed to initiate further measures. In addition, possible fault states of a floating tube 4 detected by the evaluation unit 8 can be forwarded to a monitoring system, which is designed to display the corresponding faults. The monitoring system can be part of the system 2.

By way of the transmission of the first detection signal via the first signal connection 14 from the detection system 6 to the evaluation unit 8, the corresponding information about the geometric arrangement of the floating tube 4 and/or the floating state of the floating tube 4 is provided to the evaluation unit 8. The detection system 6 can be designed and/or configured to detect the geometric arrangement of the floating tube 4 and/or the floating state of the floating tube 4 periodically and/or at predetermined times. A new detection signal can be generated by the detection system 6 with each detection of the geometric arrangement and/or the floating state. The detection system 6 can be configured correspondingly for this purpose. In addition, the detection system 6 is in this case preferably designed in such a way that each newly generated detection signal is transmitted via the first signal connection 14 from the detection system 6 to the evaluation unit 8. Due to the choice of the time intervals between the detection times of the geometric arrangement or of the floating state, a continuous, quasi-continuous or periodic detection of the geometric arrangement of the floating tube 4 can be achieved. The same is true for the transmission of information by means of the detection signal via the first signal connection 14. The corresponding information about the geometric arrangement and/or the floating state of the floating tube 4 can thus be made available to the evaluation unit 8 continuously, quasi-continuously or periodically. With each update of the geometric arrangement of the floating tube 4 and/or of the floating state of the floating tube 4, the evaluation unit 8 can perform a new check of this information for a possible fault state of the floating tube 4. The evaluation unit 8 is preferably configured accordingly for this purpose.

The evaluation unit 8 is preferably configured, on the basis of the geometric arrangement of the floating tube 4, to detect a first fault state of the floating tube 4 if tube portions 12 of the floating tube 4 are arranged crossing one another. On the basis of the geometric arrangement of the floating tube 4, the evaluation unit 8 can be configured to detect tube portions 12 of the floating tube 4 that are arranged crossing one another.

A further, advantageous embodiment of the system 2 with a floating tube 4, a detection system 6 and an evaluation unit 8 is shown in FIG. 2. The system 2 additionally has a buoy 18. The system 2 corresponds at least substantially to the system 2 explained with reference to FIG. 1, wherein, however, the system 2 shown in FIG. 2 has a greater number of tube segments 16, which are coupled to one another in series one behind the other. Due to the length of the resultant floating tube 4, it may be that the second end 30 of the floating tube 4 is raised above a tube portion 12 between the two ends 28, 30 of the floating tube 4. This can occur with a very strong swell of the water of the sea. In the geometric form of the floating tube 4 as shown in a schematic plan view in FIG. 2, a tube segment 16 lies on another tube segment 16. In this case, each of the two mentioned tube segments 16 can form a tube portion 12 of the floating tube 4 and are arranged crossing one another. However, it is also possible that a coupling region between two tube segments 16 is arranged above a further tube segment 16. In this case, the tube portion that is arranged on the other tube segments 16 can form a corresponding tube portion 12 of the floating tube 4. A crossing arrangement of tube portions 12 of the floating tube 4 is not limited to a right-angled arrangement of the two tube portions 12 of the floating tube 4. Rather, it may also be that the two tube portions 12 are arranged at another, arbitrary angle, in particular a flat angle or an acute angle, relative to one another. Crossing tube portions 12 of the floating tube 4 thus occur, for example, when the floating tube 4 is arranged geometrically in the manner of a loop. Due to the tube portions 12 of the floating tube 4 that cross one another, high mechanical stresses may occur, in particular at the stated tube portions 12 of the floating tube 4. Using this floating tube 4 to conduct a fluid through the floating tube 4 should therefore be avoided. On the basis of the geometric arrangement of the floating tube 4 detected by the detection system 6 and on the basis of the transmission of this geometric arrangement by means of the detection signal via the first signal connection 14 to the evaluation unit 8, the evaluation unit 8 can detect a first fault state of the floating tube 4 if the geometric arrangement represents at least two tube portions 12 of the floating tube 4 that are arranged crossing one another. The evaluation unit 8 can be configured to identify crossing tube portions 12 of the floating tube 4 on the basis of the geometric arrangement and by means of pattern recognition, which can be carried out by the evaluation unit 8. Other configurations of the evaluation unit 8 are likewise possible. For example, the evaluation unit 8 can be trained, for example by means of an artificial neural network, to detect crossing tube portions 12 of the floating tube 4 on the basis of the geometric arrangement.

FIG. 3 shows a further advantageous embodiment of the system 2 in a schematic side view The system 2 corresponds substantially to the system 2 explained in conjunction with FIG. 1. Reference will therefore be made analogously to the corresponding explanations.

The evaluation unit 8 of the system 2 is preferably designed to detect a second fault state of the floating tube 4 on the basis of the geometric arrangement of the floating tube 4 if a tube portion 12 of the floating tube 4 is arranged in a state decoupled from the rest of the floating tube 4.

It is evident from the comparison of FIGS. 1 and 3 that the tube segments 16 arranged at the second end 30 of the floating tube 4 form a tube portion 12 which is separate from the rest of the tube portions 12 of the floating tube 4. The separated tube portion 12 has a distance D1 from the rest of the floating tube 4, in particular from the tube segments 16 which forms the last tube segments 16 starting from the first end 28 of the floating tube 4. FIG. 3 additionally shows an advantageous embodiment of the detection system 6. Here, precisely one node unit 20 is associated with each tube segment 16. The main unit 26 can establish a radio connection 22 to each of the note units 20. For better understanding, these radio connections 22 are not illustrated in FIG. 3. However, it can be determined on the basis of the radio connections 22 that the node unit 20 of one of the tube segments 16 of the decoupled tube portion is at a distance D2 from the node unit 20 of the last tube segment 16 of the rest of the tube segments 16 of the floating tube 4, wherein this distance D2 is greater than would be necessary for a fixed connection between the tube segments 16 in order to ensure an uninterrupted fluid channel through the tube segments 16. In other words, based on the detected relative distances on the basis of the radio connections 22 it can be detected that the node units 20 of the last tube segment 16 of the rest of the tube segments 16 and the node unit 20 of the first tube segment 16 of the decoupled tube portion 12 have a distance D1 from one another that is greater than a maximally permissible distance that insurers a fixed connection between these two tube segments 16 to establish a fluid connection. The evaluation unit 8 can thus detect, on the basis of the geometric arrangement of the floating tube 4, whether at least one tube portion 12 has a distance D1 from the rest of the floating tube 4 that is greater than a predetermined permissible distance. On this basis, the evaluation unit 8 is therefore also configured to detect a second fault state of the floating tube 4 on the basis of the geometric arrangement of the floating tube 4 if the tube portion 12 of the floating tube 4 is arranged in a state decoupled from the rest of the floating tube 4. A decoupled portion 12 of the floating tube 4 not only prevents a reliable fluid connection for conveying fluid through the floating tube 4, but the decoupled tube portion 12 may also pose a risk for other vehicles travelling on the water of the sea. The detection of the second fault state is therefore particularly important in order to ensure safe operation of the system 2.

An advantageous embodiment of the system 2 is shown in FIG. 4 and corresponds at least substantially to the system 2 explained in conjunction with FIG. 1. Reference is therefore made analogously to the corresponding explanations, preferred features and/or technical effects.

In the system shown in FIG. 4, however, the last two tube segments 16, which are arranged at the second end 30 of the floating tube 4, are fully below the water line 32. These two tube segments 16 are therefore fully submerged in the water of the sea. In FIG. 4, the radio connections 22 are illustrated by dashed lines and are constructed in particular by each of the node units 20 to the main unit 26. However, this is not the case for the two node units 20 that are attached to the tube segments 16 submerged in the water. On account of these missing radio connections 22 to the submerged node units 20, the main unit 26 can detect that the last two tube segments 16 at the second end 30 of the floating tube 4 are fully submerged in the water. Since radio connections 22 exist to the rest of the node units 20 of the tube segments 16 not submerged, the main unit 26 can detect which of the tube segments 16 are submerged, specifically the tube segments 16 of the correspondingly submerged tube portion 12. In addition, the main unit 26 can detect that the rest of the tube segments 12 are floating. On the basis of this information, the main unit 26 and therefore also the detection system 6 can detect a tube state of the floating tube 4. This tube state, in the case shown in FIG. 4, represents the tube segments 16 of the submerged floating portion 12 as submerged and the rest of the tube segments 16 as floating. The floating state of the floating tube is preferably represented by the detection signal that is transmitted by means of the first signal connection 14 to the evaluation unit 8 from the detection system 6 or the associated main unit 26 with the likewise preferred communication unit 34. The evaluation unit 8 can therefore be provided with the information regarding the floating state of the floating tube 4. Similarly to the periodic detection of the geometric arrangement, the detection system 6 can also be designed for periodic detection of the floating state of the floating tube 4. A corresponding detection signal can be generated by the detection system 6 with each detection of the floating state and transmitted to the evaluation unit 8. In practice, however, it may be that a tube segment 16 is submerged under water temporarily, although it is not damaged. The detection system 6 can therefore be designed such that a tube portion 12 is only detected as submerged if the radio connection 22 to the associated first node unit is interrupted for at least a predetermined period of time. This period of time is preferably selected and/or predetermined such that an incorrect detection of the floating state of the floating tube 4 is at least substantially eradicated. In other words, a particularly low error rate of the detection of the floating state of the floating tube 4 can be achieved by the aforementioned measure.

If a tube portion 12 is fully submerged in the water of the sea, the floating tube 4 can no longer be used to convey a fluid, in particular crude oil. This is because such a conveying operation might cause a further sinking of further tube segments 16 if one tube portion 12 of the floating tube 4 is already fully submerged in the water. This, however, must be avoided. The evaluation unit 8 is therefore also configured, on the basis of the floating state of the floating tube 4, to detect a third fault state of the floating tube 4 if at least one portion 12 of the floating tube 4 is fully submerged in the water. If a corresponding fault state has been identified by the evaluation unit 8, this information can be further transmitted from the evaluation unit 8, in particular to the monitoring system. In particular, the third fault state can be displayed on a display of the monitoring system and/or other measures can be taken on the basis of the detection of the third fault state.

A further advantageous embodiment of the system 2 is illustrated schematically in FIG. 5. The system 2 corresponds substantially to the system 2 explained in conjunction with FIG. 1. However, the floating tube 4 shown in figure has a great number of tube segments 16 which are coupled to one another in series one behind the other in order to form a floating tube from a first end 28 of the floating tube 4 uninterruptedly to a second end 30 of the floating tube 4. For the rest, reference is made at least in an analogous fashion to the advantageous explanations, preferred features, effects and/or advantages such as have been explained in conjunction with the system 2 from FIG. 1.

Due to the large number of tube segments 16 of the floating tube 4 shown by way of example in FIG. 5, it is possible that the second end 30 moves in a clockwise direction around the buoy 18 with the current of the sea. The floating tube 4 thus coils around the buoy 18. In addition, a plurality of tube segments 16 can thus be arranged laterally to one another. At their end faces, the tube segments 16 are connected to one another in such a way that an uninterrupted and fluid-tight fluid channel is formed by the floating tube 4. If, however, the floating tube 4 assumes the coiled form shown by way of example in FIG. 5, the connections at the end faces of the tube segments 16 may thus be placed under high mechanical stress. The mechanical stress may be all the greater, the more tightly the floating tube 4 is coiled around the buoy 18. A coiling of the floating tube 4 should therefore be avoided in principle. In particular, a coiling of the floating tube 4 around the buoy 18 should be avoided.

As has already been explained in conjunction with the system 2 from FIG. 1, radio connections 22 can be established between the node units 20 and in particular from the main unit 26 to each of the node units 20. For better understanding, the radio connections 22 have not been illustrated in FIG. 5. Based on the radio connection is 22 and/or based on the network 24 created by the radio connection is 22, the relative distances between the node units 20 and/or a relative distance between each of the node units 20 and the main unit 26 can be determined. The detection system 6 can be designed correspondingly for this purpose. The detection system 6 can detect the geometric form of the floating tube 4 on the basis of the relative distances. This can represent, for example, the wound form of the floating tube 4. The geometric arrangement, which in particular is represented by the geometric form of the floating tube 4, can therefore be used to determine a possible fault state, specifically the fourth fault state, if the geometric form represents a winding of the floating tube 4, such that the floating tube 4 is arranged in an at least partially coiled manner. The evaluation unit 8 is therefore configured, on the basis of the geometric arrangement of the floating tube 4, also to detect a fourth fault state if the floating tube 4 is arranged in an at least partially coiled and/or wound manner. The evaluation unit 8 can also be configured to detect a coiled and/or wound portion of the floating tube 4. This coiled and/or wound arrangement can be represented by and/or derived from the geometric arrangement. The fourth fault state can therefore be determined on the basis of the geometric arrangement by the configuration of the evaluation unit 8. The evaluation unit 8, for this purpose, can have stored a corresponding pattern recognition and/or can be designed in such a way that a pattern recognition can be carried out on the basis of the geometric arrangement of the floating tube 4, wherein is designed by means of the pattern recognition to detect a coiled and/or wound portion of the floating tube 4. Therefore, if a coiled and/or wound portion of the floating tube 4 has been detected by means of the pattern recognition, the evaluation unit will thus detect the fourth fault state.

The evaluation unit 8 can be configured to detect each of the previously explained four fault states of the floating tube 4. However, it is also possible that the evaluation unit 8 is designed to detect one of the fault states, specifically one of the first, second, third and/or fourth fault state. For example, the evaluation unit 8 can be designed to detect the first and third fault state. Another combination is likewise possible.

FIG. 6 shows a further advantageous embodiment of the system 2. This is a plan view of the system 2 as shown in FIG. 1. The floating tube 4 is referred to in the embodiment shown in FIG. 6 as a first floating tube 36. The first floating tube 36 therefore extends from a first end 28a to a second end 30a. The first floating tube 36 has a plurality of tube segments 16, which are coupled to one another in series one behind the other in order to form a continuous, fluid-tight fluid channel from the first end 28a to the second end 30. The first end 28a of the first floating tube 36 is coupled to the buoy 18. In addition, the system 2 has a further, specifically a second floating tube 38. The second floating tube 38 can be formed similarly to the first floating tube 36. The second floating tube 38 has a plurality of tube segments 16, which are coupled to one another in series one behind the other in order to form an uninterrupted, fluid-tight fluid channel from the first end 28b of the second floating tube 38 to a second end 30b of the second floating tube 38. The node units of the first floating tube 36 are denoted by reference sign 20a. The node units of the second floating tube are denoted by the reference sign 20b.

The explanations for the detection system 6 and for the evaluation unit 8 in relation to the floating tube 4 can therefore preferably be understood such that the explanations, preferred features, effects and/or advantages relate to at least one floating tube 4. For example, the detection system 6 can be designed to detect a geometric arrangement of the at least one floating tube 4, in particular the two floating tubes 36, 38. Alternatively or additionally, the detection system 6 can be designed to detect a floating state of the at least one floating tube 4, in particular of the first and second floating tube 36, 38. In addition, the detection system can be configured to generate a detection signal that represents the geometric arrangement of the at least one floating tube 4, in particular of the two floating tubes 36, 38, and/or the detected floating state of the at least one floating tube 4, in particular of the two floating tubes 36, 38. In addition, the evaluation unit 8 can be configured, on the basis of the geometric arrangement of the at least one floating tube 4, in particular of the two floating tubes 36, 38, to detect a first fault state of the at least one floating tube 4, in particular of the two floating tubes 36, 38, if tube portions 12 of the at least one floating tube 4, in particular one tube portion 12 of each of the floating tubes 36, 38, are arranged in a manner crossing one another. For example, the evaluation unit 8 can be configured, on the basis of the geometric arrangement of the first and second floating tube 36, 38, to detect a first fault state of the two floating tubes 36, 38 if a tube portion 12 of the first floating tube 36 is arranged crossing a further tube portion 12 of the second floating tube 38. Apart from the fact that the two tube portions 12 are now formed by the first and second floating tube 36, 38, the detection additionally corresponds substantially to the embodiment explained by way of example in conjunction with FIG. 2. For the embodiment of the system 2 from FIG. 2, reference is therefore made similarly to the corresponding, advantageous explanations, preferred features, effects and/or advantages as have been explained in conjunction with FIG. 2.

In addition, it will be mentioned that “having” does not exclude any other elements or steps and “one” or “a” does not exclude a multiplicity. In addition, it will be mentioned that features which have been described with reference to one of the above exemplary embodiments can also be used in combination with other features of other exemplary embodiments described above. Reference symbols in the claims should not be considered to be limiting.

### LIST OF REFERENCE SYMBOLS

2 System
4 Floating tube
6 Detection system
8 Evaluation unit
10 Flotation depth
12 Tube portion
14 Signal connection
16 Tube segment
18 Buoy
20 Node unit
20a Node unit of the first floating tube
20b Node unit of the second floating tube
22 Radio connection
24 Radio network
26 Main unit
28 First end (of floating tube)
28a First end of first floating tube
28b First end of second floating tube
30 Second end (of floating tube)
30a Second end of first floating tube
30b Second end of second floating tube
32 Water line
34 Communication unit

1.-13. (canceled)

14. A system for detecting a fault state of a floating tube, the system comprising:
a buoyant floating tube;
a detection system;
an evaluation unit;
the detection system is designed to detect a geometric arrangement of the floating tube and/or to detect a floating state of the floating tube;
the detection system is configured to generate a detection signal, which represents the detected geometric arrangement of the floating tube and/or a detected floating state of the floating tube;
the detection system and the evaluation unit are coupled via a first signal connection in order to transmit the detection signal from the detection system to the evaluation unit; and
the evaluation unit is configured:
a) on a basis of the geometric arrangement, to detect a first fault state of the floating tube if tube portions of the floating tube (4) are arranged crossing one another, and/or
b) on the basis of the geometric arrangement, to detect a second fault state of the floating tube if a tube portion of the floating tube is arranged in a state decoupled from a rest of the floating tube; and/or
c) on the basis of the floating state, to detect a third fault state of the floating tube if a tube portion of the floating tube is fully submerged in water, and/or
d) on the basis of the geometric arrangement, to detect a fourth fault state of the floating tube if the floating tube is arranged at least partially in a coiled manner.

15. The system of claim 14, wherein the floating tube (4) has a plurality of tube segments (16) that are coupled to one another in series one behind the other.

16. The system of claim 14, wherein the detection system (6) is at least partially attached to the floating tube (4).

17. The system of claim 14, wherein the system (2) has a buoyant buoy (18), wherein a first end (28) of the floating tube (4) is connected to the buoy (18).

18. The system of claim 14, wherein the detection system (6) is at least partially attached to a buoy (18).

19. The system of claim 14, wherein the detection system (6) has a plurality of node units (20), wherein each node unit (20) is designed, by an associated radio unit, to establish a radio connection (22) to each of at least two of further radio units of the node unit (20) in question, so that a radio network (24), in particular a mesh radio network, is created, wherein the node units (20) are arranged in a manner distributed over the length of the floating tube (4) or are arranged in a manner distributed between the buoy (18) and a second end (30) of the floating tube (4).

20. The system of claim 14, wherein each node unit (20) is designed to determine a relative distance to each further node unit (20), connected via a radio connection (22), on the basis of the corresponding radio connection (22), wherein at least one of the node units (20) forms a main unit (26) which is designed to collect the relative distances, determined by the further node units (20), via the radio connections (22) and/or a radio network (24), and wherein the main unit (26) is designed to determine the geometric arrangement of the floating tube (4) on the basis of the collected relative distances.

21. The system of claim 16, wherein a main unit (26) is configured, on the basis of collected relative distances, to determine a length of the tube portions (12) of the floating tube (4) and/or the distances between the tube portions (12) of the floating tube (4), so that the geometric arrangement represents at least also the length of the tube portions (12) and/or the distances between the tube portions (12), and wherein the evaluation unit (8) is configured, on the basis of the length of the tube portions (12) and/or the distances between the tube portions (12), to detect a missing mechanical connection between two tube portions (12) arranged in series one behind the other.

22. The system of claim 19, wherein
a main unit (26) or a main unit (26) formed by one of the node units (20) is configured to establish a direct or indirect radio connection (22) to each further node unit (20) via the radio network (24),
wherein the main unit (26) is configured to identify each node unit (20) connected to the main unit (26) by the corresponding radio connection (22) as a floating node unit (20),
wherein the main unit (26) is configured to identify each node unit (20) not connected to the main unit (26) by a radio connection (22) as a submerged node unit (20), and
wherein the main unit (26) is configured to determine the floating state of the floating tube (4) on the basis of an identification of the floating node units (20) and/or the submerged node units (20) in such a way that the floating state for each tube portion (12) of the floating tube (4) indicates whether a particular tube portion (12) is either floating or submerged.

23. The system of claim 14, wherein the detection system (6) is designed to transmit the detection signal to the evaluation unit (8) via the first signal connection (14).

24. The system of claim 14, wherein the first signal connection (14) is a wireless radio connection (14).

25. The system of claim 14, wherein the evaluation unit (8) is arranged at a distance from the floating tube (4) and/or the detection system (6).

26. The system of claim 14, wherein the evaluation unit (8) is stationary.
